(19) United States
(12) Patent Application Publication
(10) Pub. No.: US 2012/0186158 A1
(43) Pub. Date: Jul. 26, 2012

(54) DOOR DRIVE DEVICE HAVING TRACTION MEANS MONITORING AND DOOR PROVIDED THEREWITH

(75) Inventor: Michael Sanke, Rheda-Wiedenbruck (DE)

(73) Assignee: HORMANN KG ANTRIEBSTECHNIK, Steinhagen (DE)

(21) Appl. No.: 13/388,187

(22) PCT Filed: Jul. 26, 2010
(86) PCT No.: PCT/EP2010/060788

§ 371 Date: Apr. 12, 2012

(30) Foreign Application Priority Data
Jul. 31, 2009 (DE) 102009035622.3
Aug. 28, 2009 (DE) 102009049911.3
Sep. 1, 2009 (DE) 102009039623.3

(51) Int. Cl. E05D 13/00

(52) U.S. Cl. 49/322

(57) ABSTRACT

The invention relates to a door drive device (11) for driving a door leaf (18) of a door (10), comprising a traction mechanism (13) designed in particular as a rope drive, the mechanism comprising a traction means monitoring device (28) for monitoring a breakdown of a traction means (Z1, Z2). In order to provide a simple design, which can be installed with particular ease, yet ensures safe operation, the traction means monitoring device (28) consists of mechanical blocking devices (150, 160) acting in opposing door movement directions and blocking when the traction means tension of an associated traction means (Z1, Z2) decreases and a load monitoring device (78) for a motor drive assembly (49) for load interruption when one of the blocking devices (150, 160) blocks.

The invention relates to a door drive device having a traction means monitoring device and to a door provided therewith.

Many overhead doors are provided with traction mechanisms, such as, in particular, rope drives, via which opening forces can be transmitted to the door leaf. In the raised state, the door leaf thus hangs from the ropes. On the one hand, pretensioning forces of a weight compensating device, but increasingly also drive forces of a door drive are transmitted via the rope drive. In general, rope drives are provided on each of the vertical sides of the door. If a rope now tears, then the door drive continues to drive the door leaf via the other rope, which is then put under load not only by the door leaf, but additionally also by the drive forces. Although arresting devices for avoiding a fall in the event of a rope breakage are known, which arresting devices, if the rope breaks, trigger an arresting catch in order thus to secure the door leaf, there is a high risk that, if the drive continues, the pull rope on the other side will tear. For this reason, it is established standard practice for each shaft-driven door drive which is currently on the market that, in addition to slack rope protection devices which protect the door leaf from falling, it is also necessary to provide slack rope switches, which disable the door drive in the event of rope breakage in order to be able to meet basic pertinent safety standards and receive a license for the door drive.

The installation and wiring of the slack rope switch, and the slack rope switch itself, add to the complexity and cost of known door drive devices of this kind.

The object of the invention is to provide a door drive device which can be more easily installed at the place of use and which, despite simpler and cheaper construction, is more reliable than previous door drive devices.

This object is achieved by a door drive device having the features of the appended claim 1.

Advantageous embodiments of the invention are the subject of the subclaims.

A door provided with such a door drive device is the subject of the accessory claim.

The invention provides a door drive device for driving a door leaf in an opening direction and in a closing direction via a traction mechanism having at least one first traction means and at least one second traction means, which traction means, during operation of the door drive device, are tensioned, wherein a traction means monitoring device, which is configured both to monitor a breakage or loss of tension of the first traction means and to monitor a breakage or loss of tension of the second traction means, is provided, the traction means monitoring device comprising:

a first mechanical blocking device, which is provided with a first blocking element, which in a blocking position blocks or hampers the movement of the door leaf in the closing direction but permits a movement of the door leaf in the opening direction and in a release position releases the movement of the door leaf in the closing and opening directions, and with a first tension sensing and holding device for sensing a traction means tension of the first traction means and for holding the first blocking element in dependence on this traction means tension, wherein the first tension sensing and holding device holds the first blocking element in the release position and, in the event of a reduction in tension of the first traction means, induces or enables a movement of the first blocking element by a first pretensioning force into its blocking position,
a second mechanical blocking device, which is provided with a second blocking element, which in a blocking position blocks or hampers the movement of the door leaf in the opening direction but permits a movement of the door leaf in the closing direction and in a release position releases the movement of the door leaf in the closing and opening directions, and is provided with a second tension sensing and holding device for sensing a traction means tension of the second traction means and for holding the second blocking element in dependence on this traction means tension, wherein the second tension sensing and holding device holds the second blocking element in the release position and, in the event of a reduction in tension of the second traction means, induces or enables a movement of the second blocking element by a second pretensioning force into its blocking position,
and a load monitoring device for monitoring a motor drive assembly for breaching of a load threshold, which motor drive assembly, for the driving of the door leaf, is to be connected up to the traction mechanism.

In an advantageous embodiment of the invention, it is provided that the traction mechanism is a pull rope mechanism, which transmits the rotary movement of a shaft, rotatably driven by the motor drive assembly, to the door leaf and has at least one first rope as the first traction means and at least one second rope as the second traction means.

In an advantageous embodiment of the invention, it is provided that on a first of two opposite sides of the door leaf is respectively provided at least one first rope, wherein the first blocking device and/or the first tension sensing and holding device is arranged only on this first of the two opposite sides in order to monitor only the tension of the at least one first rope on this first side.

In an advantageous embodiment of the invention, it is provided that on a second of two opposite sides of the door leaf is respectively provided at least one second rope, wherein the second blocking device and/or the second tension sensing and holding device is arranged only on this second of the two opposite sides in order to monitor only the tension of the at least one second rope on this first side.

In an advantageous embodiment of the invention, it is provided that on the first of the two sides is provided the first blocking device for monitoring the tension of the at least one first rope on this first side, and that on the remaining second side of the two sides is provided the second blocking device for monitoring the tension of the at least one second rope on this second side.

Preferably, the traction means monitoring device has neither a slack rope switch, nor otherwise an electrical or electronic rope tension sensor which has to be wired up.

In an advantageous embodiment of the invention, it is provided that the blocking devices are respectively configured as an arresting catch device having an arresting catch as the blocking element,

that as the counterbearing for the arresting catches are provided latching devices having a row of latching teeth or latching openings, which block a relative movement of latching device and arresting catch in a blocking direction, said arresting catch having been moved into the blocking position, and permit such movement in an opposite direction, involving sliding over the arresting catch, and
that the blocking devices of the first and of the second blocking device are oppositely directed.

In an advantageous embodiment of the invention, it is provided that the load monitoring device is set such that it registers a changed load caused by some intervention of each of the first and second blocking devices, in order to switch off the motor drive assembly.

In an advantageous embodiment of the invention, it is provided that the traction mechanism is pretensioned in the opening direction with a third pretensioning force—in particular of a weight compensating device—and that the load monitoring device is set to register a released pretensioning force in the event of breakage of the traction means and blockage by the first blocking device.

In one concrete embodiment, a door leaf which has to be raised for opening purposes is pretensioned by a spring device for weight compensation. If a closure of the door leaf is blocked, then this is held in the raised position by the blocking device; i.e. the spring force of the spring device is released and thus increases the motor load of the door drive moving in the closing direction. The load monitoring device is set to detect this load change.

In an advantageous embodiment of the invention, it is provided that the load monitoring device, for the purpose of monitoring the load, is set up to monitor a load-dependent parameter of the motor drive assembly, such as, in particular, the motor current, the motor output or a rotation speed.

In an advantageous embodiment of the invention, it is provided that the load monitoring device, by registering that motional direction of the door within which a blocking by one of the blocking devices is effected and/or registering the type and/or amount of a change in load caused by intervention of one of the blocking devices, is configured to detect at which traction means a tension has declined.

According to a further aspect, the invention also relates to a door provided with a traction means monitoring device according to the invention.

Illustrative embodiments of the invention are explained in greater detail below with reference to the appended drawing, in which:

FIG. 1 shows a top view of an automatically driven door in the form of a sectional door having a door drive device, the latter having a traction mechanism and a motor drive assembly on a door drive configured as a shaft-driven door drive;

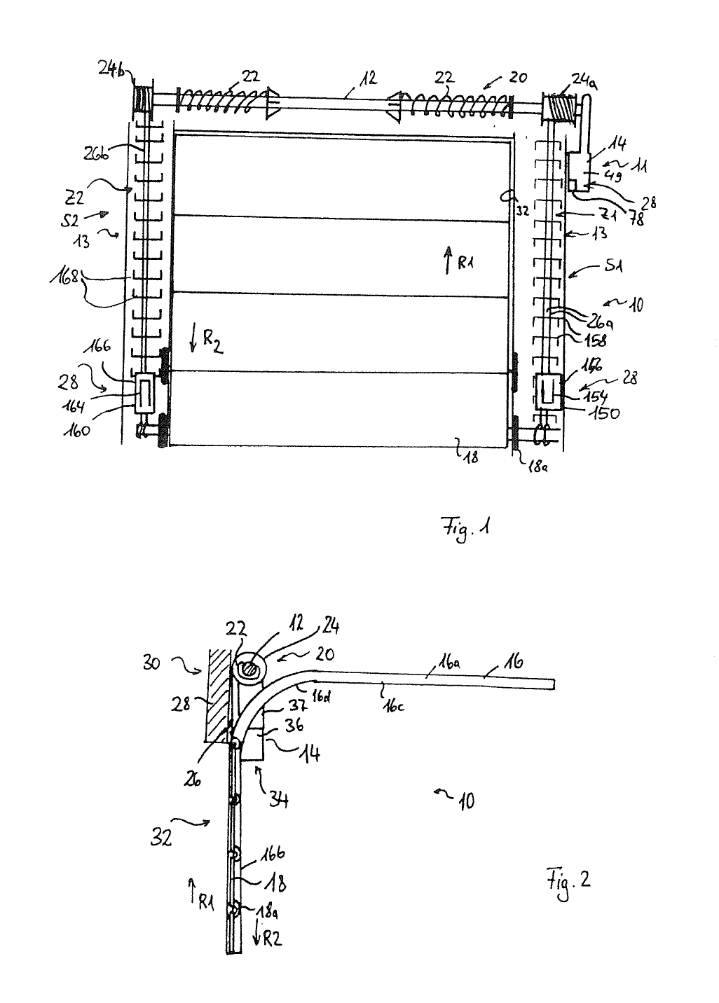

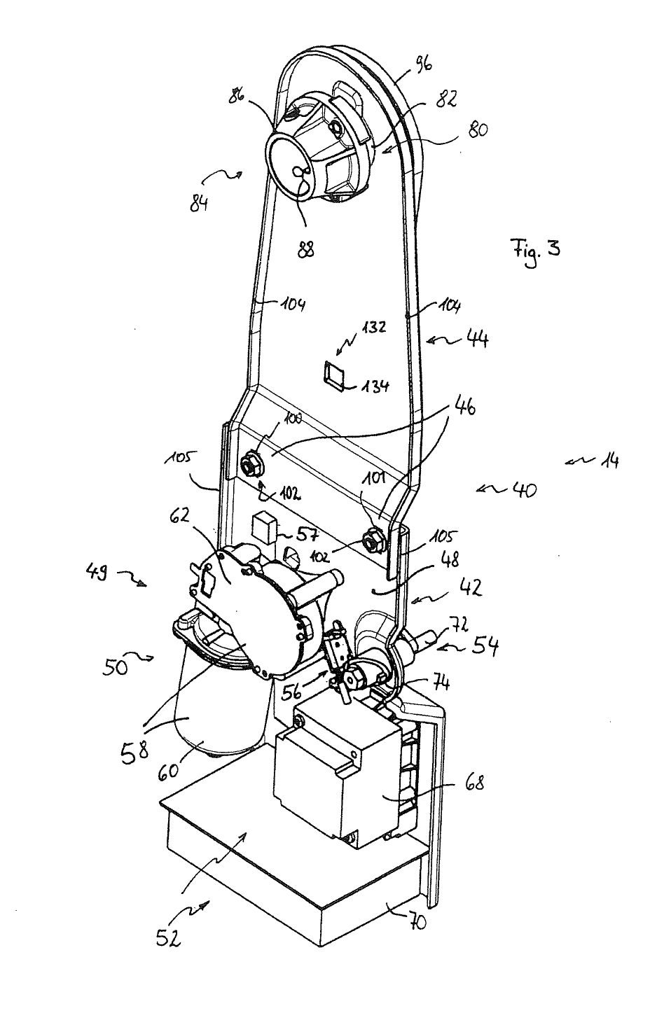

FIG. 2 shows a schematic, partially sectioned side view of the door with door shaft and shaft-driven door drive,

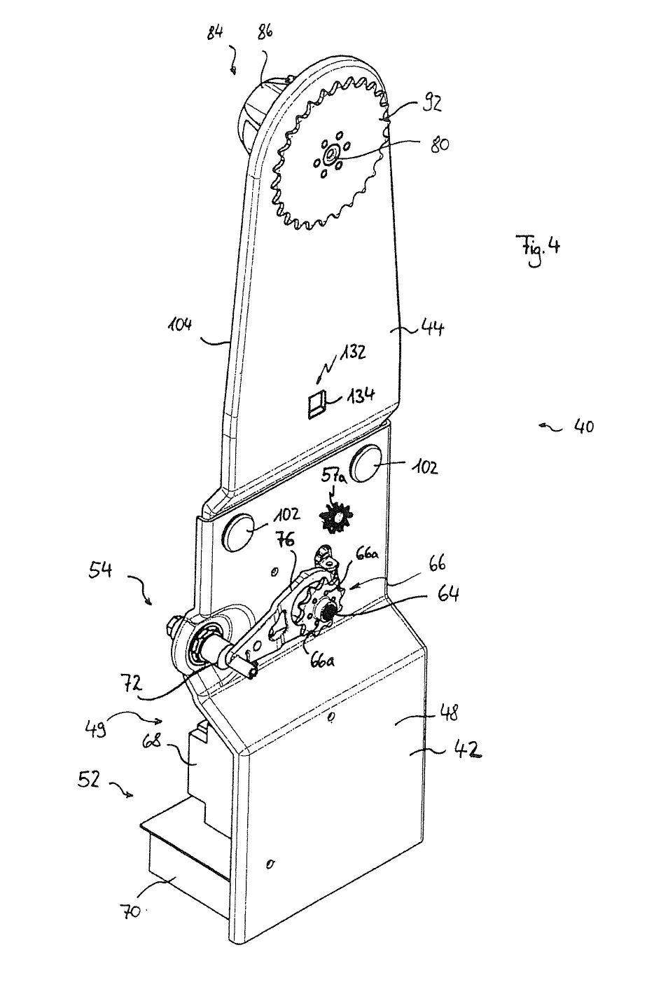

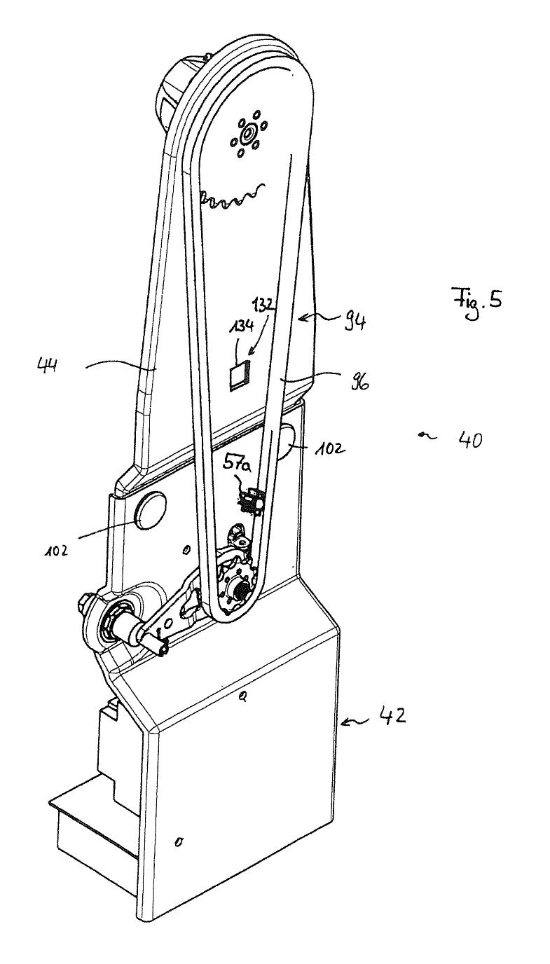

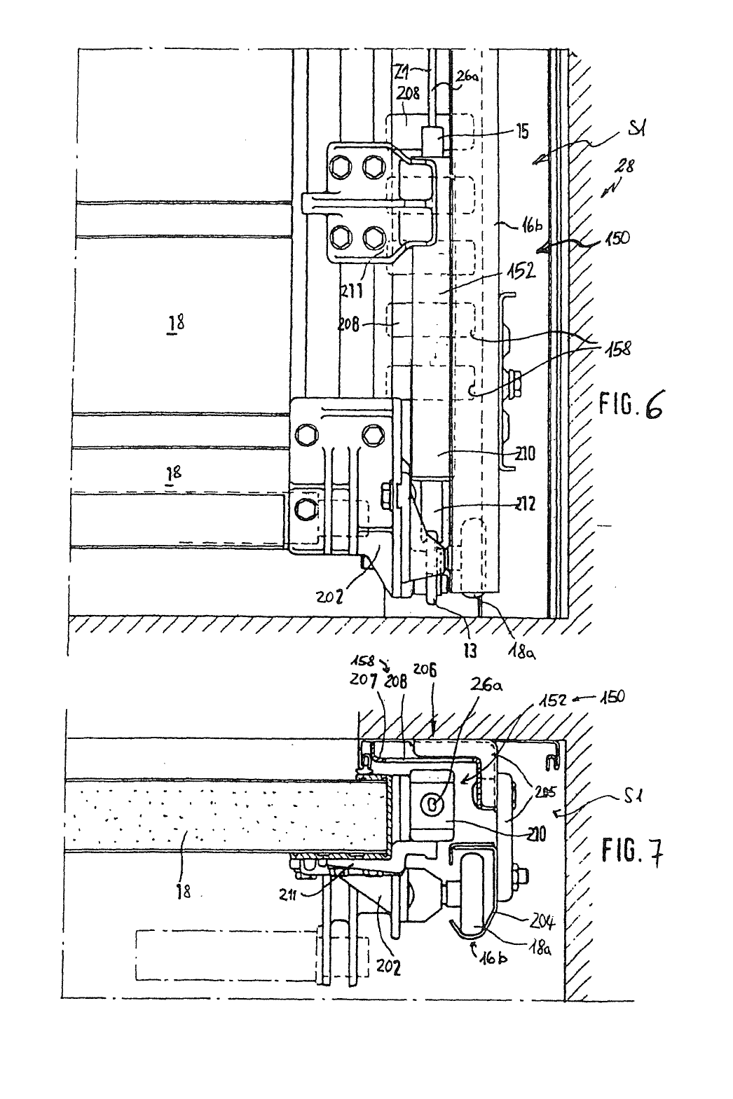

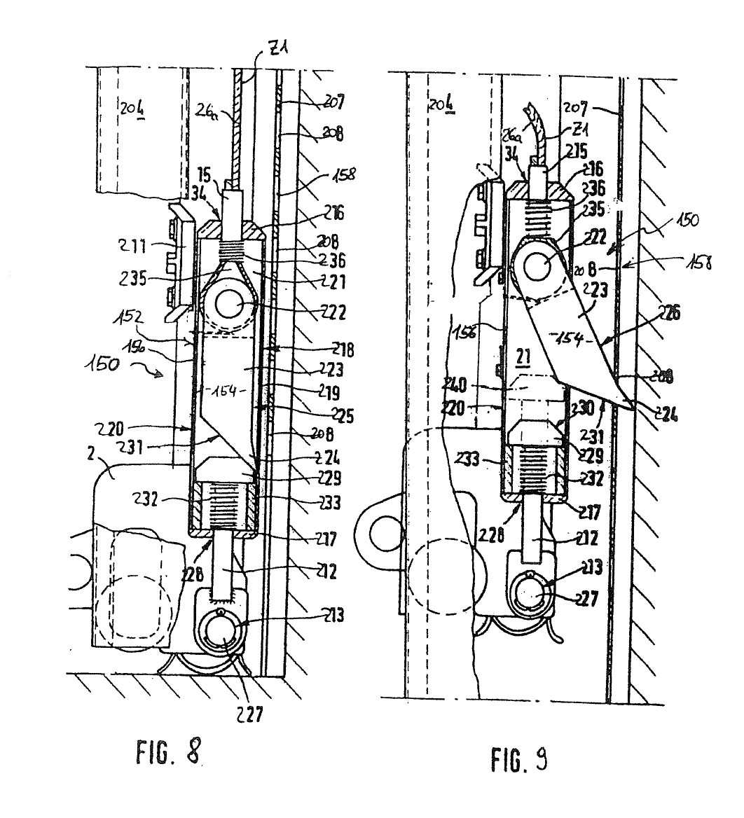

FIG. 3 shows a first perspective view of a basic structure of the shaft-driven door drive with motor, electrical unit and output shaft;

FIG. 4 shows a second perspective view of the basic structure of the shaft-driven door drive;

FIG. 5 shows a view comparable to that of FIG. 4, with inserted gear mechanism between the motor shaft and the output shaft;

FIG. 6 shows a detailed view of a right-hand bottom corner of the door represented purely schematically in FIG. 1, with a first blocking device;

FIG. 7 shows a horizontal section through the right-hand bottom corner region of the door, shown in FIG. 6;

FIG. 8 shows a right-hand side view of the right-hand bottom corner region of the door, shown in FIG. 6, in a normal operating state;

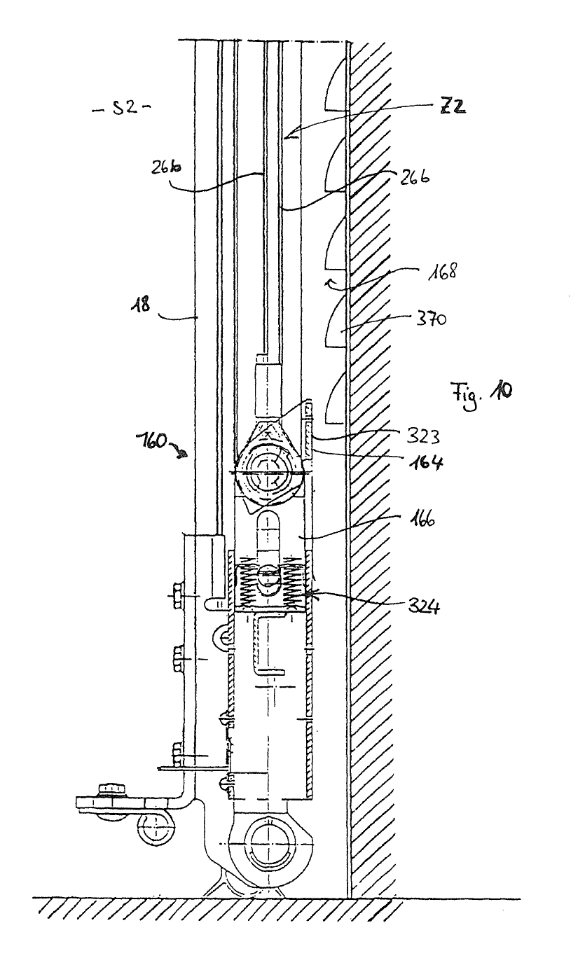

FIG. 9 shows a view comparable to that of FIG. 8, in a blocking position;

FIG. 10 shows a laterally inverted, partially sectioned side view of a left-hand bottom corner region of the door represented purely schematically in FIG. 1, with a second blocking device.

In FIGS. 1 and 2 is represented an automatically drivable door 10 having a door drive device 11, the latter having a door shaft 12, a traction mechanism 13 and a door drive 14 configured as a shaft-driven door drive or direct drive.

The door 10 has a door leaf 18, which is movable in a guide 16 between a closing end position and an opening end position in the opening direction R1 and the closing direction R2. The door shaft 12 is configured as part of a weight compensating device 20 and has an energy store, here in the form of two torsion springs 22, which exerts a pretensioning force in the opening direction R1 in order as far as possible to balance out the weight of the door leaf 18 in the course of its movement. To this end, the door shaft 12 is gear-coupled to the door leaf 18 by means of the traction mechanism 13 in such a way that the door shaft 12 rotates upon movement of the door leaf 18.

In the represented illustrative embodiment, upon movement of the door shaft 12 in the counterclockwise direction (viewed from the right in FIG. 1), which movement is driven by the door drive 14, the door leaf 18 is hoisted into the upwardly directed opening direction R1 by means of the traction mechanism 13. Upon rotation of the door shaft 12 in the clockwise direction (viewed from the right in FIG. 1), the traction mechanism 13 is relieved of load, whereupon the door leaf 18 by virtue of its own weight broadly maintains a tension in the traction mechanism 13 and moves downward in the closing direction R2 until it is in the closing end position shown in FIG. 1.

For the sake of better clarity, the representation of the guide 16 is omitted in FIG. 1. As can be seen from FIG. 2, the guide 16 has on each side a running rail 16a for rollers 18a of the door leaf 18, which running rail has a vertical rail region 16b, a horizontal rail region 16c and a curved transition region 16d therebetween. The door leaf 18 is guided in the guide 16 in a manner which is precisely matched on both sides, so that it runs very smoothly in the guide 16 and runs squarely, even when there is purely one-sided traction on just one of the two sides S1, S2 extending in the opening and closing directions.

The traction mechanism 13 has on a first side S1 of these vertical sides of the door 10 at least one first traction means Z1, and on the opposite other, second side S2 of the vertical sides of the door 10 at least one second traction means Z2. In the represented example, the traction mechanism 13 has, on the door shaft 12, rope drums 24a and 24b disposed in jointly rotating arrangement, namely a first rope drum 24a on the first side S1 and a second rope drum 24b on the second side S2. As the first traction means Z1 are provided, in the represented embodiment, at least two parallel-acting first ropes 26a in the form of wire ropes, which can be wound on the first rope drum. As the second traction means Z2, are provided, on the second side, at least two parallel-acting second ropes 26b, likewise in the form of wire ropes. In an inexpensive and therefore preferred embodiment (not represented), only one wire rope respectively is provided on each side.

The traction means Z1 and Z2 are designed such that both the at least one first traction means Z1 and the at least one second traction means Z2 are respectively capable of singly holding and moving the door leaf 18 over the whole of its course, even if the respectively other traction means on the other of the sides S1, S2 were to fail.

The door drive device 11 further has a traction means monitoring device 28, by means of which a breakage of the first traction means Z1 and a breakage of the second traction means Z2, or a decline in tension of one of the traction means Z1 or Z2, which decline occurs for other reasons, for example a breakage of a torsion spring 22, is monitored, and in such a situation the operation of the automatic door is halted after at most one further door run.

The door drive 14 is connected to one end of the door shaft 12 for the rotatable driving of the same.

FIG. 2 further shows walls 28 of a building 30 which has a door aperture 32 that can be closed by the door 10. The door drive 14 is produced in industrial mass production and is adaptable in its production such that it can be adapted to different doors 10 and different buildings 30 with corresponding installation situations.

As can be seen from FIG. 2, the door drive 14 has a drive housing 34. The drive housing 34 has a plurality of hoods or covers 36, 37. In the actual drive housing 34, the drive elements are fastened on a bearing structure or basic structure 40.

FIGS. 3 to 5 show the door drive 14 without the covers 36 and 37, so that the drive elements and the basic structure 40 is visible.

The basic structure 40 has a first basic structure part 42 and a second basic structure part 44, which are detachably connected to each other at a mounting interface 46.

The first basic structure part 42 is configured as a ground plate or base plate 48. Fastened to the base plate 48 is a motor drive assembly 49 comprising a motor 50, an electrical unit 52, a decoupling device 54 and a decoupling sensor 56.

The motor 50 is configured as a geared motor and has a motor housing 58, an electric motor 60 and a self-locking worm gear 62. Accordingly, the output shaft of the motor 50, which is hereinafter referred to as the motor shaft 64, is connected to the output shaft (not represented) of the worm gear 62. This motor shaft 64 has—as is best represented in FIG. 4—a first gearwheel in the form of a first chain pinion 66.

The electrical unit 52 has a power unit 68 with transformer and power electronics, as well as a control system 70 which controls the electric motor 60 via the power unit 68.

The motor shaft 64 can be decoupled from the worm gear 62 by means of the decoupling device 54, so that the first chain pinion 66 can rotate freely in the decoupled state. To this end, the decoupling device 54 has a coupling pin 72, which is manually rotatably actuated by actuating elements (not represented in detail) and which, when rotated, is axially movable in a controlled manner via a cam 74 (represented in FIG. 3). This axial movement is transmitted by a coupling claw 76 acting as a lever element (see FIG. 4) to the pins (not represented) on the motor shaft 64, so that these can be moved in the axial direction out of their engagement with engagement openings 66a on the first chain pinion 66.

In the decoupled state, the first chain pinion 66 is hence freely rotatable on the motor shaft 64.

The decoupling sensor 56 registers a movement of the coupling pin 72 and thus a decoupling operation.

The motor 50 is further provided with an absolute value transmitter (not represented in detail), which delivers to the control system 70 the absolute rotational angle position of the worm gear 62.

The control system 70 is configured such that, upon receipt of a signal of the decoupling sensor 56, which signal indicates a coupling state which has been reestablished after a decoupling operation, it performs a reference run for the door 10, in which the position, in particular the end positions, of the door leaf 18 are programmed. Alternatively or additionally, the or a further absolute value transmitter 57 is provided by means of a transmitter pinion 57a for picking up the door position on a drive chain of a traction means gear mechanism 94 (described later in greater detail). Since the transmitter pinion 57a rotates jointly with the door shaft 12 even in the decoupled state, the fresh programming run after the recoupling operation is no longer necessary.

In addition, in the control system 70 is provided a load monitoring device 78, which monitors a load of the motor 50 and, in the event of overload, causes the motor 50 to be switched off. The load monitoring device monitors at least one of various load-dependent parameters of the motor 50, such as, in particular, the motor current, the power consumption of the motor 50, or the rotation speed of the motor measured via the absolute value sensor, etc. In particular, the load monitoring device is configured, as described and represented more precisely in EP 0 083 947 B1, such that in the reference run a desired value for the monitored parameter is recorded as a function of the path polled via the absolute value transmitter and, with the addition of a differential value, is adopted as the switch-off threshold. Parameters of the traction means monitoring device 28 have a bearing on the formation of the differential value, as is represented in greater detail further below.

According to FIGS. 3 to 5, the second basic structure part 44 is likewise configured as a plate, which can be connected to the base plate 48 via the mounting interface 46. The second basic structure part 44 has an output shaft 80 of the door drive 14, which is rotatably mounted on a bearing 82 arranged at a certain radial distance from the motor shaft 64. The output shaft 80 has on one side a shaft coupling 84 having a connection part 86 which can be mounted on the end of the door shaft 12.

In the mounting operation, a radially inward pointing projection 88 engages a longitudinal groove (not represented) present on the door shaft 12, so that the connection part 86 sits in a rotationally secure manner on the door shaft 12.

At the other end, the output shaft 80 has a second gearwheel, here in the form of a second chain pinion 92. The two gearwheels on the motor shaft 64 and the output shaft 80 can be gear-connected to each other via the traction means gear mechanism 94. In the here represented embodiment, the traction means gear mechanism 94 has a drive chain 96.

For the fastening of the second basic structure part 44, the first basic structure part 42 has two openings, the mounting interface 46 on the second basic structure part 44 has openings 100, 101 provided with spacing corresponding to the openings of the first basic structure part 42. Reaching through these openings on the basic structure parts 42, 44 are screw fasteners 102, so as to fasten together the two basic structure parts 42, 44.

Both the first and the second basic structure part 42, 44 is provided with an angled-off, for example bent-over marginal region 104, 105. At the mounting interface 46, the two basic structure parts 42, 44 telescopically interlock with their angled-off marginal regions 104, 105. The openings on one of the two basic structure parts 44, 42 are realized as long holes. In the here represented example, the openings 100, 101 are realized on the second basic structure part 44 as such long holes. The long holes 106, 108 have a width which is smaller than the diameter of the circular openings on the other basic structure part.

The first basic structure part 42 serves to fasten the door drive 14 in the vicinity of the door shaft 12 and has for this purpose, for example, not represented in detail, screw openings for the door drive fastening. The second basic structure part 44 is realized as a modular drive element and can be replaced by other second basic structure parts, which provide a different distance of the output shaft 80 from the motor drive assembly 49 and/or different transmission ratios as a result of a different chain pinion 92 having a different number of chain teeth.

The structure of the traction means monitoring device 28 is explained in greater detail below with renewed reference to FIG. 1. The traction means monitoring device 28 has a purely mechanically working first blocking device 150 on the first side S1 and a purely mechanically working second blocking device 160 on the second side S2, and, additionally thereto, the load monitoring device 78.

The first blocking device 150 is provided with a first blocking element 154 and with a first tension sensing and holding device 156. The first blocking element 154 is pretensioned into a blocking position, in which it captures a first latching device 158 configured on the guide 16, to be precise on the vertical rail region 16b, and thus blocks a return run of the door leaf 18 in the closing direction R2. In the opening direction R1, the first blocking element 154 driven into the blocking position can slide over the first latching device 158, however, so that the door leaf 18, even with the first blocking element 154 extended, can move onward in the opening direction R1. The first tension sensing and holding device 156 senses the traction means tension of the at least one first traction means Z1 and, if a traction means tension is present, holds the first blocking element 154 in a release position in which the first blocking element 154 is released from the first latching device 158, so that the door leaf 18 is freely and easily movable. In the event of a loss of traction means tension of the first traction means Z1, the first tension sensing and holding device 156 is moved by a pretensioning into a second position in which it releases the first blocking element 154, so that the latter travels into the blocking position by virtue of its own pretensioning.

The second blocking device 160 is comparably configured, with the difference that it is active in the opposite direction to the first blocking device 150.

Accordingly, the second blocking device 160 is provided with a second blocking element 164 and with a second tension sensing and holding device 166. The second blocking element 164 is pretensioned into a blocking position, in which it captures a second latching device 168 configured on the guide 16, to be precise on the vertical rail region 16b, and thus blocks a run of the door leaf 18 in the opening direction R1. In the closing direction R2, the second blocking element 164 driven into the blocking position can slide over the second latching device 168, however, so that the door leaf 18, even with the second blocking element 164 extended, can move onward in the closing direction R2. The second tension sensing and holding device 166 senses the traction means tension of the at least one second traction means Z2 and, if a traction means tension is present, holds the second blocking element 164 in a release position in which the second blocking element 164 is released from the second latching device 168, so that the door leaf 18 is freely and easily movable. In the event of a loss of traction means tension of the second traction means Z2, the second tension sensing and holding device 166 is moved by a pretensioning into a second position in which it releases the second blocking element 164, so that the latter travels into the blocking position by virtue of its own pretensioning.

The more precise structure of the blocking devices 150, 160 is explained in greater detail below with reference to the representation in FIGS. 6 to 10, wherein FIGS. 6 to 9 show an embodiment of the first blocking device 150 and FIG. 10 shows an embodiment of the second blocking device 160, which, in terms of the working direction and in terms of the configuration of the latching device, is modified in relation to the embodiment of the first blocking device 150.

The first blocking device 150 is configured in the form of an arresting apparatus 152. As can be seen, in particular, from FIGS. 6 and 7, the rollers 18a are fastened by roller holders 202 to the door leaf 18 and guided in guide rails 204 of the guide 16. The guide rails 204 are secured by means of mountings 205 in the region of the boundary 206 of the door aperture 32.

In the example represented in FIGS. 6 and 7, arresting rails 207 are at the same time fastened to the mountings 205. In further embodiments (not represented in detail), said arresting rails can also be configured in one piece with the guide rails 204. The arresting rails 207 have the first latching device 158, which is formed by a row of arresting openings 208 on the arresting rails 207, which arresting openings follow one after the other in the longitudinal direction. In the embodiment represented in FIGS. 6 to 9, the arresting openings 208 are configured by holes punched easily out of the arresting rail 207, in a more preferred embodiment, which in FIG. 1 and FIG. 10 is indicated for the second blocking device 160, the arresting openings 208 are formed by press-outs, so that in the opening direction inclined planes for the sliding over of the first blocking element 154 are formed, the boundary of which inclined planes, pointing in the opening direction R1, acts as a counter to the blocking of the first blocking element 154 in the closing direction R2. In the narrow-side region of the door leaf 18 is arranged a blocking element housing 210, which forms a first holding part of the first tension sensing and holding device 156. That side of the housing which lies opposite the arresting rail 207 is engaged by a guide fitting 211, so that the blocking element housing 210, which in the blocking situation is displaced in relation to the door leaf 18 along its narrow side, cannot, with the first blocking element 154 in the blocking position, escape in the direction away from the arresting rail 207.

FIG. 6, as also FIGS. 8 and 9, shows a bolt 212, which is configured as a further part of the first tension sensing and holding device 156 and which, at 213, engages a fastening bolt 227, wherein 213 can be an eyelet within a tab. This bolt 212 reaches through the lower end face 217 of the blocking element housing 210 into the interior thereof. Through the upper end face 216 situated opposite this lower end face is guided a clamping sleeve 215, with which a first rope (wire ropes) 26a, here serving as a first traction means Z1, is combined to form a loop.

The part-sectional representations according to FIGS. 8 and 9 show clearly the configuration of the blocking element housing 210 and of the structural parts assigned thereto. The blocking element housing 210 has within its longitudinal side wall 218 facing the arresting rail 207 a lateral opening 219 for penetration by the first blocking element 154, which opening 219 lies opposite the housing side 220 which is supportingly engaged by the guide fitting 211. Further lateral housing walls 221, which extend perpendicular to the longitudinal side wall 218 and to the housing side 220 and of which, due to the sectional representation, only the rear one is evident, hold between them a pivot axle 222, about which the first blocking element 154 configured as an arresting catch 223 is pivotably mounted. These housing walls 221 with the pivot axle 222 are configured such that they are telescopically displaceable in relation to the longitudinal side wall 218 and the housing side 220 and thus form a second holding part of the tension sensing and holding device 156.

As revealed by FIG. 8, the swivel catch, together with a catch boss 224 configured to capture the latching device 158, is located within the blocking element housing 210 when the arresting catch 223, due to a sufficient tension state in the associated rope 26a, is in the release position, constituting the normal operating situation. The bolt 212, which is held by means of the eyelet 213 and the fastening bolt 227 in the lower side region of the door leaf 18, reaches displaceably through the lower end face 217 through a lead-through opening 228. In its end region, the bolt 212 is provided with a head 229, which is constructed widened in such a way that the side faces of the head 229 is guided on the housing inner walls. Between the inner wall of the lower end face 217 of the blocking element housing 210 and the thereto opposing bottom face of the head 229 is provided a pretensioning element (in the example a helical compression spring 232) for the delivery of a first pretensioning force. Around the helical compression spring 232 is arranged a sleeve-shaped stop 233, which in turn is supported at one end against the inner face of the end face 217 and at the other end against the thereto facing bottom face of the head 229.

As shown in FIG. 8, the bolt 212, when the rope 26a is tensioned, is with its head 229 in contact with the stop 233, so that the helical compression spring 232 has its greatest possible compression.

On the head 229 is configured a bevel 230. In a complementary manner, on the arresting catch 223, starting from the catch boss 224, is configured an oblique face 231, which bears against the bevel 230.

If the rope 26a tears, the first pretensioning force of the helical spring 232 displaces the housing 210 downward. Furthermore, the pivot axle 222 is displaced by a further helical spring 236 relative to the housing 210. The arresting catch 223 is thus forced by the bolt 212 outward into its blocking position, as is represented in FIG. 9. The head is there represented, at 240, in a dash-dot line.

The second blocking device 160 shown in FIG. 10 is represented comparably to the first blocking device, but does not bring about a blockage in the closing direction, but rather in the opening direction. Accordingly, the second arresting catch 323 used as a second blocking element 164 is correspondingly oppositely directed; and the second latching device 168 has downwardly directed latching projections 370, via which the second arresting catch 323, which has been deflected upon breakage of the second rope 26b, can slide away downward upon movement of the door leaf 18. The deflection occurs through the action of a second pretensioning force, which is provided by a spring unit 324. In the event of an upward movement, however, the catch boss 324 of the second arresting catch 323 engages the lower edge of the next-higher latch boss of the second latching device 168 and thus blocks onward travel of the door leaf 18 in the upward direction, should the second rope 26b break.

The differential value of the load monitoring device 78 is precisely set such that each blocking of one of the two blocking devices 150, 160 which is provoked by slackening of a tension in one of the traction means is registered and leads to the door drive 14 being switched off, in particular such that the motor 50 initially travels slightly in the opposite direction in order to relieve the remaining traction means of load.

As a result of the bidirectional blocking facility, all situations involving a failure of one of the traction means Z1, Z2 can be registered. At latest following completion of the corresponding run in which the failure occurs and upon the attempt of a run in the opposite direction, the blockage is active, so that the door drive 14 is immobilized and no further loading of the remaining traction means occurs.

If the first rope 26a tears, for example, then the door leaf 18 can be moved, still with the first blocking element 154 extended, upward in the opening direction R1, where the door leaf 18 is prevented from falling down and moving in the closing direction R2 by the first blocking device 150. If the door drive 14 is then reactuated so as to move the door leaf in the closing direction R2, then the door shaft 12 is moved without the door leaf 18. The rotation must then take place counter to the third pretensioning force of the weight compensating device, and thus with greater force. This can be registered by the load monitoring device 78 and is used to switch off the door drive 14. Moreover, the second traction means Z2 is also then slackened, so that the second blocking device 160 also intervenes and a displacement of the door leaf 14 in either direction is blocked. The remaining traction means Z2 is thereby relieved of load, without any danger of the door leaf 18 falling.

If, on the other hand, the second traction means Z2 tears, then, if movement is made in the opening direction R1, a corresponding blockage by the second blocking device 160 takes place immediately.

Consequently, at the door drive 14 is generated an increased load, which is registered by the load monitoring device 78 and leads to the door drive 14 being switched off.

If the traction means tension of the second traction means Z2 declines in the course of a closing run, then, even though the second blocking device 160 is triggered, the door leaf 18 still then travels into the closing position, where it is prevented by the second blocking device 160 from making a fresh run in the opening direction R1, which in turn leads to a switching off.

Based on the nature or site of the load disconnection, and/or the direction of travel during which the switching off takes place, the control system 70 can thus establish on which side S1, S2 a drop in tension occurs and can deliver a corresponding error report, for instance as clear text.

Further, unrepresented embodiments are possible. For instance, the second latching device 168 does not have to extend over the entire region of the vertical guide 16b—as represented in FIG. 1. It is sufficient if only a lower region is provided with the second latching device 168. If the second traction means Z2 then falls in the closing position represented in FIG. 2, constituting the most frequent operating state of the door, then the second blocking device 160 is directly blocked and the door 10 cannot be opened. To this end, for instance, the second latching device, viewed from below, is provided only with about 3 to 10 second latching elements, which can be captured by the arresting catch 323. It could thus be that, above that region of the guide 16 which is represented in FIG. 10, no latching elements of the second latching device 168 are any longer present. In a preferred embodiment, above the last latching element of the second latching device 168, right up to the highest position of the second blocking device 160, is then provided a further first latching device 158, having corresponding latching elements for preventing a descent of the door leaf 18 in the closing direction R2.

In this embodiment, the second arresting catch 323 is either designed such that it can rest against the first latching device 158 counter to a movement in the closing direction R2 and can rest against the first latching device 168 counter to a movement in the opening direction R1. In another alternative embodiment, the second blocking element 164 is configured with two arresting catches, namely, on the one hand, with a first arresting catch 223 and, on the other hand, with a second arresting catch 323, which are both triggered in the event of breakage of the second traction means Z2.

### REFERENCE SYMBOL LIST

10 door
11 door drive device
12 door shaft
13 traction mechanism
14 door drive
16 guide
16a running rail
16b vertical rail region
16c horizontal rail region
16d curved transition region
18 door leaf
18a roller
20 weight compensating device
22 torsion spring
24a first rope drum
24b second rope drum
26a first ropes
26b second ropes
28 traction means monitoring device
30 building
32 door aperture
34 drive housing
36 cover
37 cover
40 basic structure
42 first basic structure part
44 second basic structure part
46 mounting interface
48 base plate
49 motor drive assembly
50 motor
52 electrical unit
54 decoupling device
56 decoupling sensor
57 absolute value transmitter
57a transmitter tooth
58 motor housing
60 electric motor
62 worm gear
64 motor shaft
66 first chain pinion (gearwheel)
66a engagement openings
68 power unit
70 control system
72 coupling pin
74 cam
76 coupling claw
78 load monitoring device
80 output shaft
82 bearing
84 shaft coupling
86 connection part
88 projection
92 second chain pinion
94 traction means gear
96 drive chain
100 opening on the second basic structure part
101 opening on the second basic structure part
102 screw fastener
104 angled-off marginal region
105 angled-off marginal region
150 first blocking device
152 arresting apparatus
154 first blocking element
156 first tension sensing and holding device
158 first latching device
160 second blocking device
164 second blocking element
166 second tension sensing and holding device
168 second latching device
202 roller holder
204 guide rails
205 mountings
206 boundary
207 arresting rails
208 arresting openings
210 blocking element housing
211 guide fitting
212 bolt
213 eyelet
215 clamping sleeve
216 upper end face
217 lower end face
218 longitudinal side wall
219 lateral opening
220 housing side
221 lateral housing walls
222 pivot axle
223 (first) arresting catch
224 catch boss
228 through opening
227 fastening bolt
229 head
230 bevel
231 oblique face
232 helical compression spring
233 stop
236 helical spring
240 bolt deflected relative to the housing
323 second arresting catch
324 spring unit
370 latching projection
R1 opening direction
R2 closing direction
S1 first side
S2 second side
Z1 first traction means
Z2 second traction means

1. A door drive device for driving a door leaf in an opening direction and in a closing direction via a traction mechanism having at least one first traction means and at least one second traction means, which traction means, during operation of the door drive device (11), are tensioned, wherein a traction means monitoring device, which is configured both to monitor a breakage or fall in tension of the first traction means and to monitor a breakage or fall in tension of the second traction means, is provided, the traction means monitoring device comprising:
a first mechanical blocking device, which is provided with a first blocking element, which in a blocking position blocks or hampers the movement of the door leaf in the closing direction but permits a movement of the door leaf in the opening direction and in a release position releases the movement of the door leaf in the closing direction and opening direction, and with a first tension sensing and holding device for sensing a traction means tension of the first traction means and for holding the first blocking element in dependence on this traction means tension, wherein the first tension sensing and holding device holds the first blocking element in the release position and, in the event of a reduction in tension of the first traction means, initiates a movement of the first blocking element by a first pretensioning force into its blocking position, a second mechanical blocking device which is provided with a second blocking element, which in a blocking position blocks or hampers the movement of the door leaf in the opening direction but permits a movement of the door leaf in the closing direction and in a release position releases the movement of the door leaf in the closing direction and opening direction, and with a second tension sensing and holding device for sensing a traction means tension of the second traction means and for holding the second blocking element in dependence on this traction means tension, wherein the second tension sensing and holding device holds the second blocking element in the release position and, in the event of a reduction in tension of the second traction means, initiates a movement of the second blocking element by a second pretensioning force into its blocking position, and a load monitoring device for monitoring a motor drive assembly for breaching of a load threshold, which motor drive assembly, for the driving of the door leaf, is to be connected up to the traction mechanism.

2. The door drive device as claimed in claim 1, wherein
the traction mechanism is a pull rope mechanism, which transmits the rotary movement of a shaft, rotatably driven by the motor drive assembly, to the door leaf and has at least one first rope as the first traction means and at least one second rope as the second traction means.

3. The door drive device as claimed in claim 2, wherein
on a first of two opposite sides of the door leaf, which sides preferably extend in the opening and closing directions, is respectively provided at least one first rope, wherein the first blocking device and/or the first tension sensing and holding device is arranged only on this first of the two opposite sides in order to monitor only the tension of the at least one first rope on this first side.

4. The door drive device as claimed in claim 2, wherein
on a second of two opposite sides of the door leaf, which sides preferably extend in the opening and closing directions, is respectively provided at least one second rope, wherein the second blocking device and/or the second tension sensing and holding device is arranged only on this second of the two opposite sides in order to monitor only the tension of the at least one second rope on this second side.

5. The door drive device as claimed in claim 3, wherein
on the first of the two sides is provided the first blocking device for monitoring the tension of the at least one first rope on this first side, and that on the remaining second side of the two sides is provided the second blocking device for monitoring the tension of the at least one second rope on this second side.

6. The door drive device as claimed in claim 2, wherein
the traction means monitoring device has no slack rope switch and no tension sensors, which have to be wired up, for monitoring the rope tension.

7. The door drive device as claimed in claim 1, wherein
the blocking devices are respectively configured as arresting catch devices having an arresting catch as the blocking element,
in that as the counterbearing for the arresting catches are provided latching devices having a row of latching teeth or latching openings, which block a relative movement of device and arresting catch in a blocking direction, said arresting catch having been moved into the blocking position, and permit such movement in an opposite direction, involving sliding over the arresting catch, and in that the blocking devices of the first and of the second blocking device are oppositely directed.

8. The door drive device as claimed in claim 7, wherein
the tension sensing and holding devices respectively have a first and a second holding part which can be moved closer together in a telescopically displaceable manner and are held one against the other, and which are pretensioned in a pushed together state and are held counter to this pretensioning in a pulled apart state by the traction means tension which is to be sensed, wherein in the pulled apart state they hold the assigned arresting catch in the release position thereof, wherein the arresting catch, upon movement into the pushed together state, can be moved under the action of the pretensioning force into its blocking position.

9. The door drive device as claimed in claim 1, wherein
the load monitoring device is set such that it registers a changed load caused by some intervention of each of the first and second blocking devices, in order to switch off the motor drive assembly.

10. The door drive device as claimed in claim 9, wherein
the traction mechanism is pretensioned in the opening direction with a third pretensioning force, and in that the load monitoring device is set to register the released third pretensioning force in the event of a loss of traction means tension and blockage by a blocking device.

11. The door drive device as claimed in claim 1, wherein
the load monitoring device, for the purpose of monitoring the load, is set up to monitor a load-dependent parameter of the motor drive assembly, such as, in particular, the motor current, the motor output or a rotation speed.

12. The door drive device as claimed in claim 1, wherein
the load monitoring device, by registering that motional direction of the door within which a blocking by one of the blocking devices is effected and/or by registering the type, the site and/or amount of a change in load caused by intervention of one of the blocking devices, is configured to detect at which traction means a tension has declined.

13. An automatically driven door including a door drive device as claimed in claim 1.

14. The door drive device as claimed in claim 3, wherein
on a second of two opposite sides of the door leaf, which sides preferably extend in the opening and closing directions, is respectively provided at least one second rope, wherein the second blocking device and/or the second tension sensing and holding device is arranged only on this second of the two opposite sides in order to monitor only the tension of the at least one second rope on this second side.

15. The door drive device as claimed in claim 4, wherein
on the first of the two sides is provided the first blocking device for monitoring the tension of the at least one first rope on this first side, and that on the remaining second side of the two sides is provided the second blocking device for monitoring the tension of the at least one second rope on this second side.

16. The door drive device as claimed in claim 3, wherein
the traction means monitoring device has no slack rope switch and no tension sensors, which have to be wired up, for monitoring the rope tension.

17. The door drive device as claimed in claim 2, wherein
the blocking devices are respectively configured as arresting catch devices having an arresting catch as the blocking element, in that as the counterbearing for the arresting catches are provided latching devices having a row of latching teeth or latching openings, which block a relative movement of device and arresting catch in a blocking direction, said arresting catch having been moved into the blocking position, and permit such movement in an opposite direction, involving sliding over the arresting catch, and in that the blocking devices of the first and of the second blocking device are oppositely directed.

18. The door drive device as claimed in claim 2, wherein
the load monitoring device is set such that it registers a changed load caused by some intervention of each of the first and second blocking devices, in order to switch off the motor drive assembly.

19. The door drive device as claimed in claim 2, wherein
the load monitoring device, for the purpose of monitoring the load, is set up to monitor a load-dependent parameter of the motor drive assembly, such as, in particular, the motor current, the motor output or a rotation speed.

20. The door drive device as claimed in claim 2, wherein
the load monitoring device, by registering that motional direction of the door within which a blocking by one of the blocking devices is effected and/or by registering the type, the site and/or amount of a change in load caused by intervention of one of the blocking devices, is configured to detect at which traction means a tension has declined.
